(19) United States
(12) Patent Application Publication
(10) Pub. No.: US 2007/0163671 A1
(43) Pub. Date: Jul. 19, 2007

(54) METHOD AND DEVICE FOR NON-CONTACTING MONITORING OF A FILLING STATE

(76) Inventors: Stefan Boehm, Schwulper (DE); Ludwig Danzer, Wendelstein (DE); Sven Rathmann, Braunschweig (DE); Jan Wrege, Wolfenbuttel (DE)

Correspondence Address: SCHIFF HARDIN, LLP;PATENT DEPARTMENT, 6600 SEARS TOWER, CHICAGO, IL, 60606-6473, US

(21) Appl. No.: 11/622,550

(22) Filed: Jan. 12, 2007

(30) Foreign Application Priority Data
Jan. 12, 2006 (DE) 10 2006 001 668.8

(51) Int. Cl. B65B 1/04; B65B 3/04; G01B 11/02; B65B 31/00

(52) U.S. Cl. 141/1; 356/496; 141/18

(57) ABSTRACT

In a method and a device for non-contacting monitoring of the fill state of liquids in an unpressurized liquid container, the fill state and/or the fill state change is determined by radiating light onto the boundary region of the liquid at which a fill state-dependent curvature arises due to adhesion forces of the liquid at the reservoir wall and surface tension, and the intensity of the reflected light or the reflection angle is measured at a predetermined location.

### BACKGROUND OF THE INVENTION

1. Field of the Invention

The invention concerns a method for contact-free monitoring of the fill state of liquids in an unpressurized liquid reservoir and a device for detection of fill states and/or fill state changes in an unpressurized liquid reservoir for acceptance of a liquid.

2. Description of the Prior Art

Sensor systems for larger fill volumes and container (reservoir) sizes are generally known. These sensor systems operate with contacting or non-contacting measurement principles that are based on many different physical effects.

Examples of such different contacting measurement principles are mechanical fill state sensors operating according to the Schwimmer principle, capacitive fill state sensors, hydrostatic fill state sensors, vibration limit sensors and directed microwave fill state sensors. One significant property of the contacting measurement principles is that they can significantly influence the measurement subject in the determination of the state of the measurement value with a measurement sensor. A measurement sensor that is immersed in a liquid, or that accepts a liquid volume, exhibits an increased influence on the measured fill state as the ratio of total liquid volume to measurement sensor volume decreases. These sensor systems therefore are well-suited for large liquid volumes, but rapidly reach their limits given small liquid volumes.

Examples of non-contacting measurement principles are optical sensors, and ultrasound or radar sensors. Optical fill state sensors operate either according to the light barrier principle in transparent tubes or as immersion probes with prisms for directing radiation that either reflect the light totally or refract the light given contact with liquid. These optical sensors supply a switching level given the presence of liquid and are in principle not suitable for continuous monitoring of fill states. Ultrasound and radar fill state sensors can be used for large measurement intervals in large reservoirs.

Given small reservoirs, the fill state can be indirectly determined without influencing the liquid by the gravimetric measurement of the fill volume. This procedure requires a highly-sensitive force measurement that incurs high costs in the process environment of an automated production. Furthermore, manufacturing tolerances of the container geometry have a significant effect on the actual fill state in the container. Gravimetric measurements therefore are best suited for production on the laboratory scale.

In automated production small liquid volumes are normally output with automated dispensers that determine a volume by a monitored ejection or discharge in closed systems. This is a controlled volume emission. When the liquid is emitted into an unpressurized reservoir, no monitoring of the actual fill state achieved normally ensues. When partial volumes are extracted from the container in further process steps, the fill state generally cannot be determined without a gravimetric measurement.

Optical measurement systems are known that can measure through transparent surfaces (so as to monitor the fill state of a liquid in a container) by means of interferometric measurement principles. Due to the high costs, however, these can normally not be used in a production environment, but rather are used for research and development and statistical quality assurance. Such a measurement method is particularly relevant given under-filling of attached micro-components or upon filling of gaps between micro-components, for which it must be ensured that filling material is actually filled into the existing gap, such as by monitoring and how long the filling process takes or how far the filling process has proceeded. An exemplary special application is the design of detector components for electromagnetic radiation as used, for example, in computed tomography.

### SUMMARY OF THE INVENTION

An object of the present invention is to provide a cost-effective and simple method and a device for influence-free fill state monitoring in small open containers, wherein the monitoring does not significantly influence the filling.

The invention is based on the recognition that fill states and their state changes given small volumes in small containers can be detected very easily by the effect of different fill state-dependent light reflections in the surroundings (environment) of boundary surfaces between the liquid and an abutting wall. In this region a significant change of the orientation of the liquid surface is associated with the varying fill state If these surfaces are irradiated with light and the reflected light is measured, slight fill state changes thus can be simply detected by changes in the reflected light.

If a thin light beam is used for this purpose, a fill state change can be concluded from a varying angle of incidence. Making a precise measurement of the angle of incidence of the light beam is, however, relatively elaborate. If a light beam is used with a greater diameter, a light reflection arises with a spatial intensity that likewise changes with the change of the fill state of the liquid. It is thus sufficient to measure the intensity of the reflected light at a single location in order to detect fill state changes or previously-calibrated fill states.

Based on this recognition, the above object is achieved in accordance with the invention by a method for non-contacting monitoring of the fill state of liquids in a as unpressurized liquid reservoir, wherein the fill state and/or the fill state change is determined by radiating light onto the boundary region of the liquid at which a fill state-dependent surface curvature (meniscus) arises due to adhesion forces of the liquid at the reservoir wall and surface tension, and the intensity of the reflected light is measured at a predetermined location.

The reservoir in which the liquid quantity for under-filling of a previously-attached micro-component is located can be used as a liquid container.

The variation of the intensity of the reflected light for monitoring of an automatic dosing process can be used, with the liquid reservoir having a connection to a gap to be filled at a micro-component via a capillary and the start, the course and the end of the filling of the gap are detected by the intensity change of the reflected light

The start of the filling can be detected by a first intensity change of the reflected light and the running process of the filling can be detected by a continuous intensity change of the reflected light. The end of the filling process can be detected by the cessation of the intensity change following a previously-detected intensity change of the reflected lights or by reaching a predetermined intensity value of the reflected light.

Furthermore, the current fill level can also be determined (after previous calibration) by the current intensity of the reflected light.

A laser (preferably a laser diode) can be used as a preferred light source.

Corresponding to the basic ideas described above, the above object also is achieved in accordance with the present invention by a method for non-contacting monitoring of the fill state of liquids in an unpressurized liquid reservoir in which the fill state and/or the fill state change is determined, by radiating a light beam onto the boundary region of the liquid at which a fill state-dependent surface curvature arises due to adhesion forces of the liquid at the reservoir wall and surface tension, and the reflection angle of the reflected light beam is measured. The reflection angle can be measured, for example, using a photodetector array

If this embodiment of the method for monitoring of an automatic dosing process is used, the liquid reservoir can exhibit a connection (via a capillary) to a gap to be filled at a micro-component and the start, the course and the end of the filling of the gap are detected by the angle change of the reflected light beam. The start of the filling can be detected by a first angle change of the reflected light beam; the running procedure of the filling can be detected by a continuous angle change of the reflected light beam. The end of the filling process can be detected by the cessation of the angle change following a previously-detected angle change of the reflected light beam, or by reaching a predetermined angle of the reflected light beam.

Corresponding to the method variants described above, the above object also is achieved in accordance with the invention by a device for detection of fill states and/or fill state changes in an unpressurized reservoir for acceptance of a liquid, having a light source with a directed emission that irradiates the boundary region of the liquid in the reservoir at which a fill state-dependent surface curvature arises via adhesion forces of the liquid at the reservoir wall and surface tension, and having a detector for measurement of the reflection angle of the reflected light beam.

For example, for measurement of the reflection angle a photodetector array can be arranged in the reflection region of the light beam.

Corresponding to the basic inventive ideas, an improved device for filling of air gaps at micro-components has a reservoir for acceptance of a filling liquid, a discharge arrangement for filling the reservoir with a predetermined quantity of fluid, and a transfer arrangement for direct transfer of the liquid from the reservoir into the gap to be filled with the aid of surface tension and adhesion forces between the fluid and walls. According to the invention this device is improved by using one of the devices described above for detection of fill states and/or fill state changes.

The reservoir can thereby exhibit a connection (via a capillary) to a gap to be filled at a micro-component and/or a laser (preferably a laser diode) can be used as a light source.

This device can be connected with a computer or processor in which a computer program is stored or accessed that is executed to implement the method steps described above.

### DESCRIPTION OF THE DRAWINGS

FIG. 1 illustrates a small reservoir with varying fill states.

FIG. 2 illustrates the basic principle of light reflection at different liquid levels.

FIG. 3 schematically illustrates an embodiment of a measurement system with inventive reflection measurement.

### DESCRIPTION OF THE PREFERRED EMBODIMENTS

In the following figures, only features necessary for understanding of the invention are shown, and the following reference characters are used: 1: reservoir; 2: liquid; 3: contact point; 4: container wall; 5: liquid surface; 5′, 5″, 5″: liquid level; 6: normal; 7: incidence point; 8: light beam; 8.1, 8.2: edge rays of the light beam; 8.1′, 8.2′: reflected edge rays of the light beam; 8.1″, 8.2″: reflected edge rays given the liquid level 5″; 8.1″′, 8.2″′: reflected edge rays given the liquid level 5″′; 9: laser diode; 10: photodiode; 11: control and evaluation computer; 12: horizontal; α: angle of incidence; β: light angle of incidence; γ: vertical [plumb] angle; φ′, φ″, φ″′: reflection angles; Θ: wetting angle; h; fill height; Prgx: computer programs; x, z: coordinates.

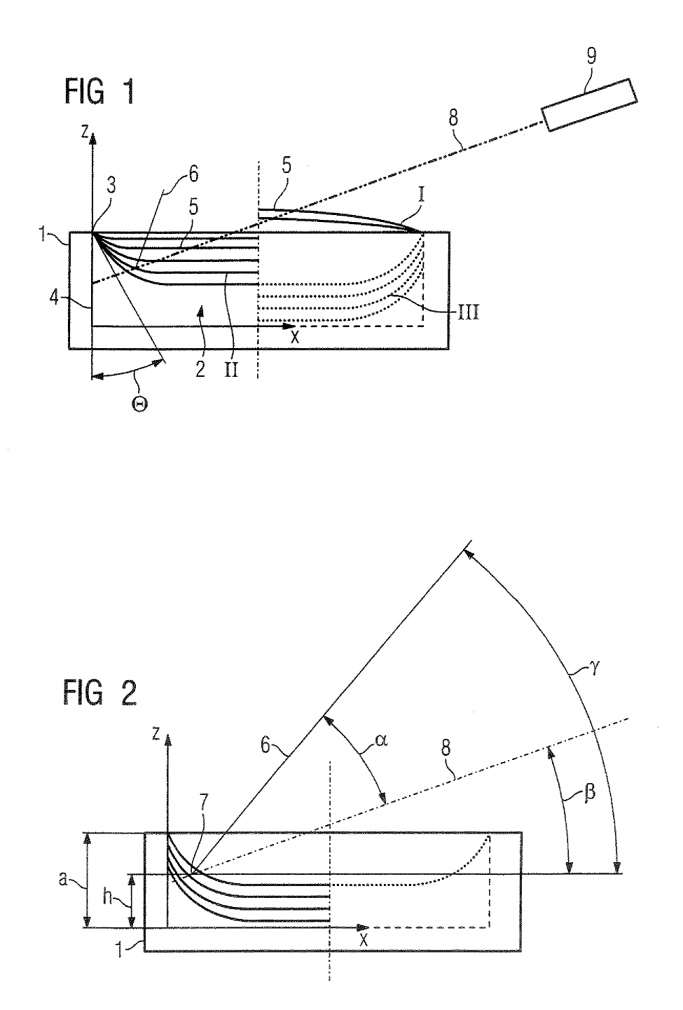

The continuous monitoring of the fill state of liquids in small reservoirs is inventively determined without contact by detecting the reflection ratio of a light ray or of a light beam to the surface curvature of the liquid that arises at the reservoir wall. In principle three states for the formation of the surface curvature occur dependent on the fill state of the liquid in the container. These three states I-III are schematically shown in FIG. 1 in a perpendicular x-z section plane through a reservoir 1.

In the state I a free surface to be wetted is made available to the liquid 2. The contact point 3 between the reservoir wall 4 and the liquid surface 5 freely shifts in the z-direction at the reservoir wall depending on the liquid volume. The wetting angle Θ and the surface curvature thereby remain constant. The wetting angle Θ depends on the wetting properties between the reservoir wall and the liquid. A concave surface curvature results given a good wetting of the reservoir surface. The surface curvature thereby significantly depends on the surface tension and the density of the liquid.

In the state II the contact point 3 between the reservoir wall 4 and the liquid surface 5 do not shift further since, given z=a, it meets the upper edge of the reservoir. With increasing liquid volume the wetting angle Θ tends towards 90° and the surface curvature tends towards 0° or, respectively, the curvature radius tend towards∞. At the end of the state II the liquid surface forms a plane at z=a.

In a state III the surface develops a convex curvature with further increasing liquid volume.

In this state the liquid volume is greater than the reservoir volume. The wetting angle exceeds 90° as long as the liquid does not wet the reservoir edge. The state III can be viewed as an unstable fill state of the reservoir since the smallest disruptions can lead to deformation of the surface curvature to the point of leakage of the excess volume In a production process this state is normally to be avoided or to be monitored within predetermined limits, which is also possible with the proposed fill state monitoring method.

Reproducible analog signal curves can be generated for the three described states with the system design shown in FIG. 2. A light ray or a light beam is directed form a light source at a defined constant light angle of incidence β onto the reservoir wall 4. Depending on the fill state, the light strikes on the liquid surface at a specific point or, respectively, region of the surface curvature. The angle γ occurring at this point of the curvature between its normal 6 and the horizontal 12 is dependent on the fill height in the reservoir in the z-direction. The vertical angle γ and therewith also the angle of incidence a can be represented as a function of the fill level over the surface curvature. In the present case of the transition of the light into an optically-denser medium a portion of the light is always refracted in the medium at the incidence point 7 and a portion is reflected on the surface. A measurement signal dependent on the fill level is obtained via the measurement of the power of the reflected light in relation to the incident light power at a specific point or via the measurement of the light angle of incidence.

By suitable geometric parameters of the system design a steady and reproducible signal curve over the three described states can be generated A monitoring of the fill state (such as, for example, failing or rising fill states, fill state differences and phase transitions) is possible via specific features such as slope and reversal points of the non-linear signal curve. The fill level h in a reservoir can be determined from the measurement signal via a calibration.

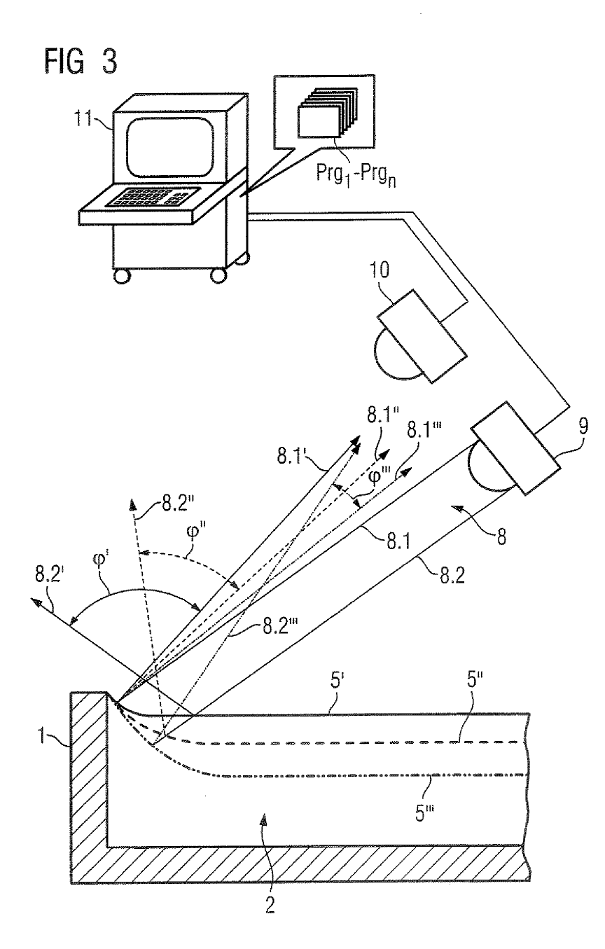

The design of a measurement system with a laser diode 9 generating a relatively broad light beam and a photodiode 10 is exemplarily shown in FIG. 3. The broad light beam 8 of the laser diode 9 with the edge rays 8.1 and 8.2 is directed onto the boundary region of the reservoir 1 (open as above) in which the liquid 2 is located. Shown are three different liquid levels with the surfaces 5′, 5″, 5″′, whereby the edge rays (8.1′ with 8.2′, 8.1″ with 8.2″ and 8.1″′ with 8.2″′) reflected on the respective liquid surfaces are drawn for each liquid level. Since the surface continuously, progressively develops with regard to its tangential direction between the points of incidence of the edge rays 8.1 and 8.2, the shown angle ranges φ′, φ″ and φ″′ describe the spatial angles in which the primary light intensity is radiated with different angle-dependent intensity. The light intensity at this location can be measured via the arrangement of a light-sensitive sensor 10 and its variation can be used as a measure for fill state change.

To control the system, in particular the laser diode 9, a control and evaluation computer 11 is connected with the light sensor 10. The information regarding the fill state or regarding the current fill state change can hereby be used in a production process likewise controlled by the computer 11.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for non-contacting monitoring of a fill state of a liquid in an unpressurized liquid container comprising the steps of:
radiating light onto a boundary region between the liquid and a wall of the container at which a fill state-dependent curvature exists due to adhesion forces of the liquid at the container wall and surface tension;
measuring an intensity of light reflected from said boundary region at a predetermined location; and
from the measured intensity, determining at least one of a fill state or a fill state change of said liquid in said container.

2. A method as claimed in claim 1 comprising employing, as said liquid container, a reservoir in which a liquid quantity for under-filling of a previously-attached micro-component is contained.

3. A method as claimed in claim 1 comprising the additional steps of detecting a variation of said intensity of the reflected light at said predetermined location, and using the detected variation to monitor an automatic dosing process of said liquid.

4. A method as claimed in claim 3 comprising, in said dosing process, supplying said liquid from said liquid container via a capillary to a gap to be filled at a micro-component, and wherein the step of monitoring said automatic dosing process comprises monitoring a start, a course, and an end of filling of said gap dependent on said detected variation.

5. A method as claimed in claim 4 comprising detecting said start of said filling by detecting a first change in said intensity of the reflected light.

6. A method as claimed in claim 4 comprising detecting said course of said filling by detecting a continuous intensity change of said intensity of said reflected light.

7. A method as claimed in claim 4 comprising detecting said end of said filling by detecting cessation of an intensity change of said intensity following a previously-detected intensity change of the intensity of said reflected light.

8. A method as claimed in claim 4 comprising detecting said end of said filling by detecting reaching of a predetermined intensity value of the intensity of said reflected light.

9. A method as claimed in claim 4 comprising determining a current fill level of said liquid in said gap by monitoring a current intensity of the reflected light with respect to a calibrated intensity.

10. A method as claimed in claim 9 comprising detecting said end of said filling by detecting cessation of an intensity change of said intensity following a previously-detected intensity change of the intensity of said reflected light.

11. A method as claimed in claim 1 wherein the step of radiating said light comprises radiating light from a laser.

12. A method as claimed in claim 11 wherein the step of radiating light from a laser comprises radiating light from a laser diode.

13. A method for non-contacting monitoring of a fill state of a liquid in an unpressurized liquid container comprising the steps of:
radiating light onto a boundary region between the liquid and a wall of the container at which a fill state-dependent curvature exists due to adhesion forces of the liquid at the container wall and surface tension;
measuring an reflection angle of light reflected from said boundary region at a predetermined location; and
from the measured reflection angle, determining at least one of a fill state or a fill state change of said liquid in said container.

14. A method as claimed in claim 13 wherein the step of measuring said reflection angle comprises measuring said reflection angle with a photodetector array.

15. A device for non-contacting monitoring of a fill state of a liquid in an unpressurized container comprising:
a light source that emits light that irradiates a boundary region between the liquid and a wall of the container at which a fill-state dependent surface curvature exists due to adhesion forces of the liquid at the wall and surface tension;
a detector that measures an intensity of said light reflected from said boundary region at a predetermined location; and
a determination unit that determines a fill state or a fill state change of said liquid in said container dependent on said intensity.

16. A device as claimed in claim 15 comprising a computer comprising said detection unit, said computer being connected to said light source and to said detector and being programmed to execute a measurement procedure by activating said light source to irradiate said boundary region.

17. A device for non-contacting monitoring of a fill state of a liquid in an unpressurized container comprising:
a light source that emits light that irradiates a boundary region between the liquid and a wall of the container at which a fill-state dependent surface curvature exists due to adhesion forces of the liquid at the wall and surface tension;
a detector that measures an reflection angle of said light reflected from said boundary region at a predetermined location; and
a determination unit that determines a fill state or a fill state change of said liquid in said container dependent on said reflection angle.

18. A device as claimed in claim 17 wherein said detector comprises a photodetector array.

19. A device as claimed in claim 17 comprising a computer comprising said detection unit, said computer being connected to said light source and to said detector and being programmed to execute a measurement procedure by activating said light source to irradiate said boundary region.

20. A device for filling air gaps in a micro-component, comprising:
a reservoir containing a predetermined quantity of filling liquid;
a transfer unit connected to said reservoir that directly transfers liquid from said reservoir into a gap in a micro-component to be filled, said gap having a gap wall and said liquid in said gap exhibiting a boundary region between said liquid and said gap wall at which a fill state-dependent surface curvature exists due to adhesion forces of the liquid at the gap wall and surface tension;
a light source that irradiates said boundary region with light;
a detector that detects a characteristic of said light reflected from said boundary region, said characteristic being selected from the group consisting of intensity of the reflected light and a reflection angle of the reflected light; and
a determination unit that determines a fill state of the filling liquid in the gap dependent on the detected characteristic.

21. A device as claimed in claim 20 wherein said transfer unit comprises a capillary between said reservoir and said gap.

22. A device as claimed in claim 20 wherein said light source is a laser.

23. A device as claimed in claim 20 wherein said light is a laser diode.
